(19) United States
(12) Patent Application Publication
(10) Pub. No.: US 2015/0203928 A1
(43) Pub. Date: Jul. 23, 2015

(54) PROCESS FOR DRY RECYCLING AND PROCESSING OF STEEL SLAG

(71) Applicant: Rolth do Brasil Indústria, Comércio e Serviços Ltda., Campinas (BR)

(72) Inventors: Decio Pedro Thome, Campinas (BR); Marcio Lagazzi Zeni, Araras (BR); Roberto Damas Moreno, Campinas (BR); Rodrigo Corrales Grigol, Campinas (BR)

(21) Appl. No.: 14/161,279

(22) Filed: Jan. 22, 2014

(51) Int. Cl. C21B 3/04; B02C 23/08

(52) U.S. Cl. CPC C21B 3/04; B02C 23/08

(57) ABSTRACT

The present invention relates to a process for recycling and processing steel slag, comprising the removal of the metal fractions of the slag in an innovative separation system and through the metal-free material, to produce granules of ore and steel shot, sealing block, apparent blocks, building blocks, interlocking floors in all models, caissons, guides, masonry mortar, adhesive mortar, floor on floor mortar, pumpable mortars, grouts, colored grouts, flexible grouts, epoxy grouts, epoxy masses, replacing natural minor aggregates, as the sand and crushing stone by steel slag in their proper particle size and especially the replacement of 100% of the conventional cement produced by a steel slag cement, applying additives from 0.1% to 30% of additives, depending on the application of each product. The invention belongs to the recycling area, specifically the recycling of steel slag.

### FIELD OF APPLICATION

The present invention belongs to the field of recycling and more specifically to dry processing and recycling of steel slag, removing the metal fraction of the slag in such an innovative process and through the metal-free material.

Through the process of the present invention, one can produce granules of ore shot and steel shot, sealing blocks, apparent blocks, building blocks, interlocking floors in all models, caissons, guides, masonry mortar, adhesive mortar, floor on floor mortar, pumpable mortars, grouts, colored grouts, flexible grouts, epoxy grouts, epoxy mass for production of floors, grouts of several strengths replacing natural lower aggregates such as sand, crushed stone by steel slag in their particle sizes with the addition of cement at 0.1% to 40%. The product obtained by the process of the present invention is particularly used in replacement of 100% of the conventional cement produced by a cement produced from steel slag, applying additives from 0.1% to 30% additives, depending on the application of each product.

### PRIOR ART

All literary processes described to date for the process to control expansion of steel slag are to develop a route from the wet process, ie, via a discontinuous process and which demands high availability of time and space to hydration by water of steel slag, which makes it unfeasible, ecologically and financially.

### OBJECTIVES OF THE INVENTION

The present invention aims to provide a process for recycling and transforming steel slag by a dry route, generating basic raw materials for obtaining, for example the following products:

1. Interlocking floors of low, medium and high mechanical strength applicable to conditions of light, medium and heavy traffic in order to provide mechanical strength that meets current standards.
2. Apparent and structural sealing blocks, normal finishing and fine finishing for internal and external environments.
3. Mortars of type AC I, AC II, AC III, adhesive mortar, “floor on floor” mortar, pumpable mortars and designed mortars.
4. Flexible grout, colored grouts and epoxy grouts.
5. Epoxy mass for the production of floors
6. Grout for structures, anchoring of equipment, recovery and all possible applications for this product.
7. Feedstock rich in CaO and MgO for the manufacture of cement, using steel slag, is this composition of cement mortars and grouts, tiles, blocks and grouts.
8. Metallic iron the following particle sizes:
a. greater than 2 mm>for the manufacture of steel blocks to return in the production process of steel fabrication in steel industry.
b. Less than 2 mm>manufacture of steel shot.

Moreover, the process aims to obtain results as:

1. The removal of metal, for inhibiting expandability.
2. Obtaining raw materials of higher strength of steel slag and with different particle sizes for fine aggregate, and
3. Obtaining raw materials of lower strength but high in calcium and magnesium oxide, to obtain fines for cement replacement.

In case of removal of metal, the steel slag, mainly composed by adding silica (SiO₂), limestone and other components of a lower percentage, is intended to perform the final purification of the steel, which can reach temperatures of 1350 and 1400° C., so that the components undergo sintering process and is incorporated into metallic iron steel slag.

In addition, metallic iron may be incorporated in different particle sizes and in different oxidation states, ranging from metal iron (Fe°) to iron monoxide (FeO) and iron oxide (Fe₂O₃). The presence of iron in different oxidation states, mainly iron monoxide (FeO—Fe₊₂), will give an extremely magnetic character to the slag, which will compete with the magnetism of metallic iron. Thus, it is used an innovative process of separation of metallic iron (as shown in the flow chart of the drawings).

### BRIEF DESCRIPTION OF FIGURES

FIGS. 1-2 is a process flow diagram for recycling and processing of steel slag according to the present invention.

### DESCRIPTION OF THE PROCESS

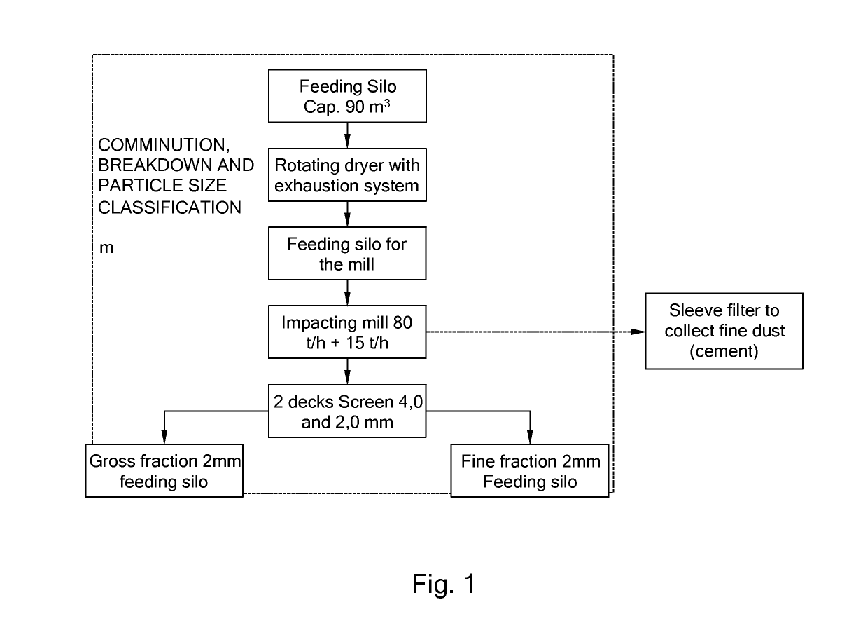

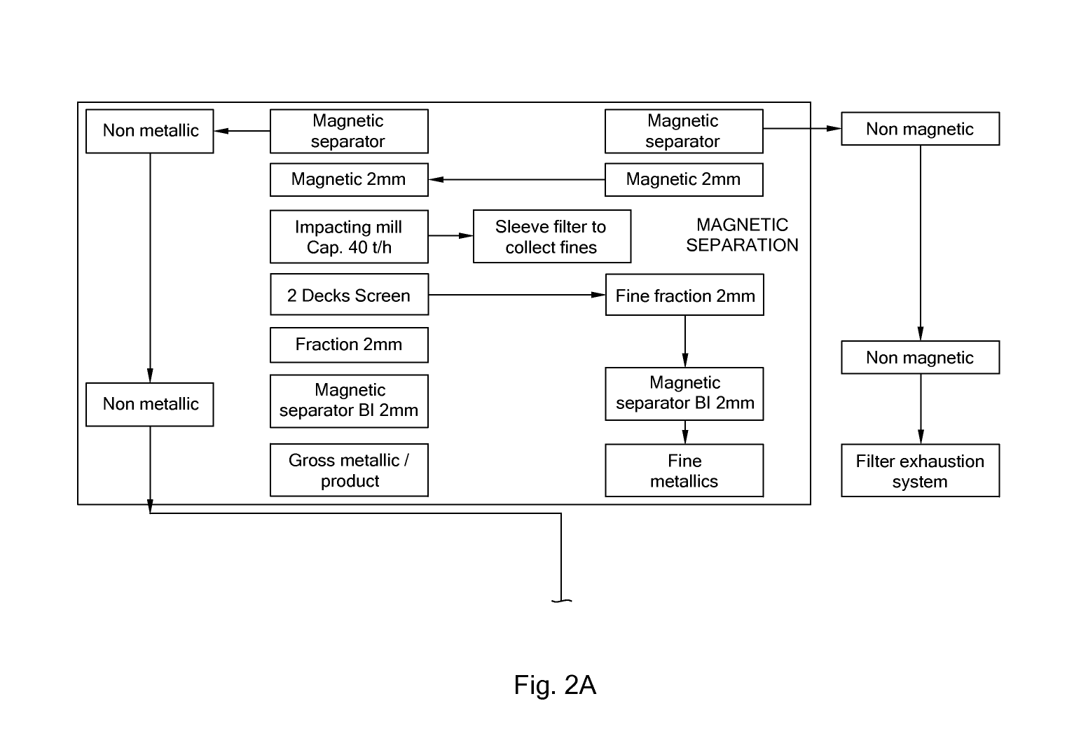

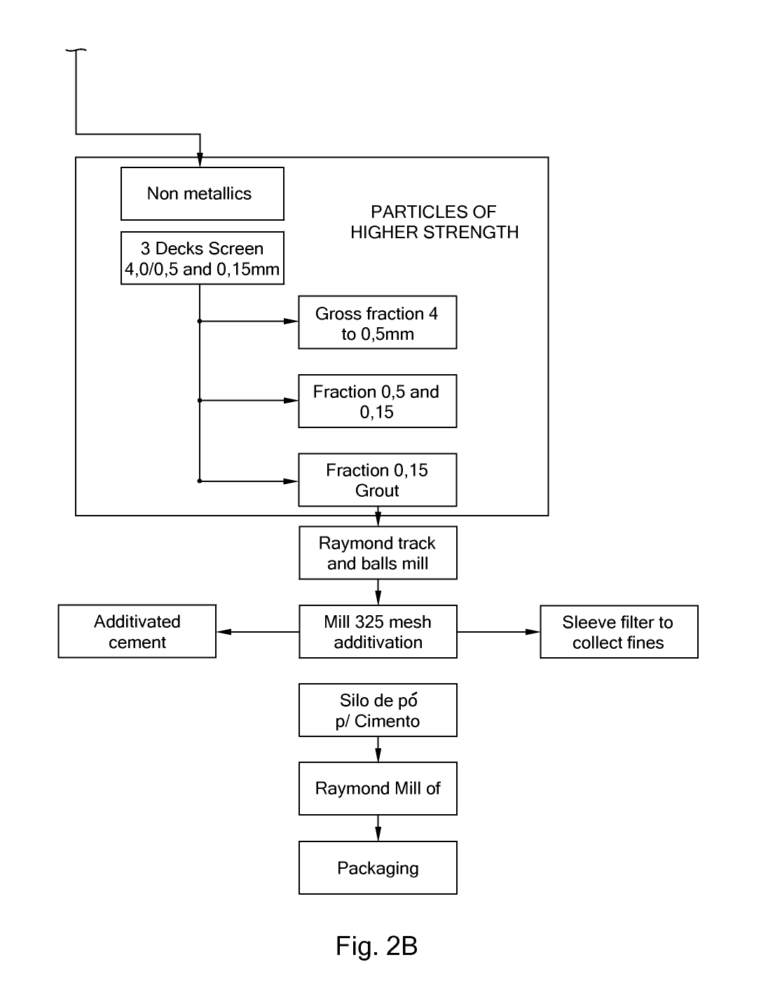

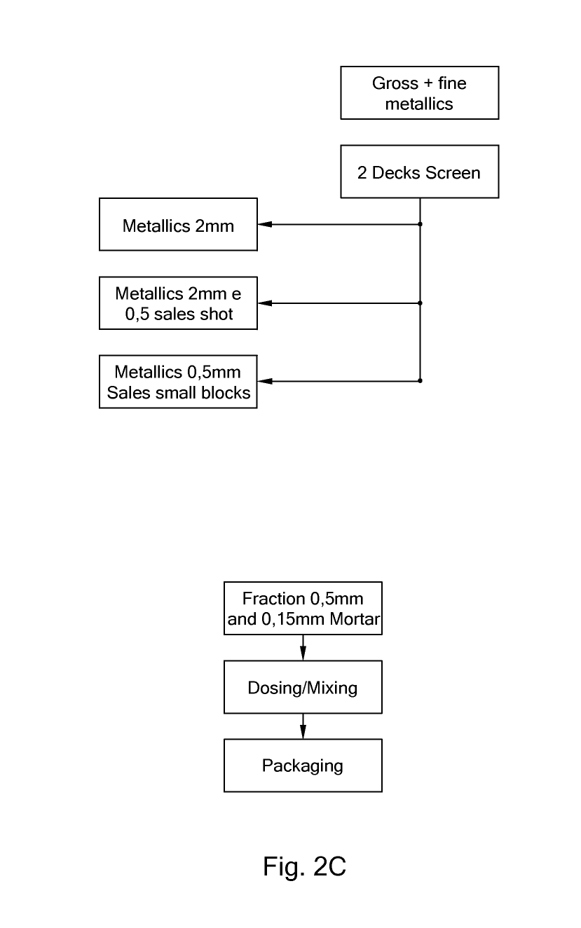

Within the context of FIG. 1, it will be observed that the process of the present invention basically comprises the following steps:
(A) comminution and breakdown by impacting mills, at a dry route;
(B) particle size classification in different sizes by screening, respecting the range of 0.074 mm to 12.50 mm, for use in the final products;
(C) magnetic separation in magnetic separators developed exclusively for the separation of metallic iron in the different particle size fractions;
(D) release of the slag associated with metallic iron through a stage of impact at impacting mills;
(E) drying the material through the rotary dryer, determining the route of control and treatment process of expandability of steel slag, by a dry route.
(F) new classification by screening, and
(G) new magnetic separation for final purification of the metal.

### Raw Materials of Higher Strength

Regarding the extraction of raw materials for added strength, the process according to the present invention has 100% economic sustainability, in which the main goal is to get all the basic raw materials for manufacture of floors, blocks, mortars, grouts and especially replacement of cement, from steel slag, after removal of the metal components.

Once done the process of disintegration, release and clearance of grains of the slag, non-magnetic fraction is used to render the grains for different applications, so you may need to meet the following additional steps depending on each intended application:
(1) define the optimal particle size for production of concrete blocks;
(2) define the grading curve for optimal packing of the grains to achieve maximum strength and lower cement consumption;
(3) define the particle size for the formulation of the mortar;
(4) define the particle size of the formulation of grout.

It is important to remember that at the process of separation of metallic components involving several stages of crushing, screening, magnetic separation at different particle size stages and final release of the slag, are automatically generated the basic raw materials for manufacture of floors, blocks, mortar and grouts.

### Raw Materials of Lower Strength

In relation to obtaining raw materials of lower strength, the item of greater economic sustainability of the project is to obtain compounds rich in CaO and MgO, which can produce raw material for cement replacement, considering that this component is the item major cost in the production of products to be developed.

In this same concept of recovering processing of metallic iron there is generated a component rich in CaO and MgO for the production of cement replacement, whereby it may be necessary to fulfill the following process steps:
(1) identification and separation of compounds rich in CaO and MgO, and
(2) setting the particle size to produce cement substitute.

### Laboratory Tests

Laboratory tests were performed, and the obtained parameters to adjust the recovery process of metallic material and obtaining of raw matter. In the tests performed, the following steps occur:
1. Processing 4,000 kg of steel slag;
2. Comminution, breakdown, separation by different ranges of particle size;
3. Magnetic separation in different particle size ranges;
4. Breakdown, release and final cleaning of metal;
5. Obtaining the raw materials, all non-magnetic fractions;
6. Identification and chemical analysis of all non-magnetic compounds;
7. Separation of slag with high and low strength;
8. Size classification of slag with higher strength, separation by range of particle size;
9. Separation of the slag of lower strength and grinding below 325 mesh;
10. Composition of particle size, with the slag of higher strength, for the manufacture of the products described above;
11. Definition of trace (relative of steel slag cement×water×additive) for interlocking floors of steel slag;

### Apparent Blocks, for Closure and Structural;

12. Composition of the particle size for the manufacture of steel slag blocks;
13. Definition of trace (relative to steel slag cement×water×additive) for blocks of steel slag;
14. Production of steel slag blocks;
15. Test of mechanical strength (to compression), water and moisture absorption;

### Concrete Blocks

16. Composition of the particle size for the manufacture of steel slag blocks;
17. Definition of trace (relative to steel slag cement x water x additive) for blocks of steel slag;
18. Production of steel slag blocks;
19. Test of mechanical strength (to compression), water and moisture absorption;

### Floors of High Strength

20. Composition of the particle size for the manufacture of high strength floors;
21. Definition of trace (relative to steel slag cement x water x additive) for floors with high mechanical strength;
22. Test of mechanical strength (to compression), water and moisture absorption;

### Mortar

23. Composition of the particle size for manufacturing mortar;
24. Definition of trace (relative to steel slag cement x water x additive) for mortar;
25. Test of strength and pullout index;

### Grouting Mass

26. Composition of the particle size for manufacturing of grouting mass;
27. Definition of trace (relative to steel slag cement x water x additive) for grouting;

28. Mechanical strength and weathering test (weather degradation);

### Production of Replacement for Cement

Once identified the raw material of lower mechanical strength rich in CaO and MgO, the raw material was comminuted to −325 mesh, then the additive of cement replacement by inserting special additives (slag activators), and implementation of test for different traces for different applications.

In more detail, it may be noted that the invention provides a process with a dry route for the control of expansion factors (CaO, MgO and metallic iron), contained in the steel slag.

During processing, it was found that the slag, when heated in a controlled manner (residence time of 30 seconds at +1300° C.), actives binding properties of the slag, as well as facilitates removal of friable material (free CaO and MgO), elements which, under normal conditions, react with water to form expandable hydroxides (CaOH₂ and MgOH₂).

The main steps involved in the process and treatment of steel slag are feeding scum, primary crushing, drying, secondary crushing, metal separation, particle size classification, dust collectors and storage of aggregates.

These steps can be described in greater detail as follows:

Feeding of slag: occurs by means of a vibratory feeder in which the slag in the primary crusher is measured;

Primary crushing: through the mill, the size of gross slag is reduced;

Drying: crushed slag is exposed at a controlled manner to determined temperature and time;

Secondary crushing: the friable material is separated into mill, whose principle of operation is the impact.

Magnetic Separation: after the grinding, fractionated slag is found with reduced content of calcium oxide (CaO) and magnesium oxide (MgO), so that all material is led to Magnetic Separation system.

Magnetic separation according to the invention takes place by means of randomly designed magnets with different intensities (Gauss) to capture particulate matter of different particle sizes.

After clearing the Metallic iron and part of the oxides (which cause expansion), the material is transported to the screening system.

Size classification: After the classification in vibrating screen, there is obtained a controlled steel aggregate with permitted levels of Cao, MgO and iron oxides, which do not react when mixed with water and cement, eliminating the expansion.

Dust collectors: it is further provided a step of sleeve filtering that collects fine friable materials, arising from the dryer, the mill and the size classification system.

Storage of aggregates: The steel crushed stone classified as superfine, fine, medium and coarse size is stored in a covered location and is ready to be used in the production of artifacts.

The steel aggregate, after being treated by the process of the present invention replaces, with huge environmental gains, natural fine aggregates commonly used in the production of artifacts, such as crushed stone and sand.

The steel crushed stone can be used in the production of concrete artifacts such as interlocking floors, sealing blocks, building blocks, caissons, guides, curb, concrete, as well as adhesive mortars, floor on floor mortar, pumpable mortar, grout, colored grouts, flexible grouts, epoxy grouts, epoxy masses.

In turn, the fines produced during processing of slag have a cement function, and can be used in addition to the conventional cement, or in some cases by additives, or used to replace 100% of the conventional cement, by a cement produced by steel slag, applying additives from 0.1% to 30% of additives depending on the application and degree of strength of each product.

With a demonstrative purpose, analytical results are shown below, which demonstrate the control of expandability of the slag processed according to the present invention.

| | TYPE OF | | | |
|---|---|---|---|---|
| TAG | ANALYSIS | STANDARD | RESULT | STANDARD RESULT |
| 14185 | Expansibility | DNIT ME 113/09 | 0.38% | Up to 3% |
| 14182 | Durability | ASTM C88-05 | 2.0% | <12% (coarse aggregate) |
| | | ASTM C33/C33M 11 | | <10% (small aggregate) |
| 14182 | Los Angeles | ABNT NBR 7211:09 | 16% | <23% |
| | Abrasion | | | |
| 141096 | Compressive | NBR 9780/87 and | Average | >35 MPa |
| | Strength | NBR 9781/87 | 38.1% | |
| 141097 | Compressive | NBR 9780/87 and | Average | >35 MPa |
| | Strength | NBR 9781/87 | 45.9% | |

It is therefore a process of recycling and transforming of steel slag by a dry route of great importance to the objective pursued, fully meeting the proposed objectives and fulfilling at a practical and efficient manner the intended functions, providing advantages inherent to its applicability, with specific and innovative characteristics and provided with fundamental requirements of novelty and inventive activity, required to obtain patent protection.

1. Pof recycling and processing steel slag at a dry route, characterized by the steps of:
(a) feeding the slag by means of a vibratory feeder in which the slag is measured in the primary crusher;
(b) primary mill crushing, wherein the size of gross slag is reduced;
(c) drying the crushed slag by controlled exposure to determined temperature and time;
(d) secondary crushing of friable material with separation at an impacting mill;
(e) magnetic separation of slag fractionated by magnets with different intensities, to capture particulate matter of different grain sizes
(f) elimination of the metallic iron and oxides;
(g) transporting the material to a screening system;
(h) particle size classification in vibrating screen with obtaining a controlled-added steel, and
(i) sleeve filtering to collect friable fine materials, from the dryer, the mill and the size classification system.
